(19) United States
(12) Patent Application Publication
(10) Pub. No.: US 2021/0357477 A1
(43) Pub. Date: Nov. 18, 2021

(54) PLANE-GEOMETRY CONSISTENCY DETECTION METHOD, COMPUTER DEVICE, STORAGE MEDIUM

(71) Applicant: YAOKE INTELLIGENT TECHNOLOGY (SHANGHAI) CO., LTD., Shanghai (CN)

(72) Inventors: Ziran XING, Shanghai (CN); Dan YANG, Shanghai (CN)

(73) Assignee: YAOKE INTELLIGENT TECHNOLOGY (SHANGHAI) CO., LTD., Shanghai (CN)

(21) Appl. No.: 17/383,419

(22) Filed: Jul. 22, 2021

Related U.S. Application Data
(63) Continuation of application No. PCT/CN2019/081424, filed on Apr. 4, 2019.

(30) Foreign Application Priority Data
Feb. 19, 2019 (CN) 201910125336.3

(51) Int. Cl. G06F 17/16; G06K 9/62; G06F 16/22

(52) U.S. Cl. CPC G06F 17/16; G06K 9/6239; G06F 16/2255; G06F 16/2237; G06K 9/6276

(57) ABSTRACT

The plane-geometry consistency detection method, the computer device, and the storage medium of the present disclosure are achieved by obtaining first normal vector set, second normal vector set, first distance set, and second distance set; obtaining pairs of the first normal vectors and an angle-matched second normal vector pair to compute a first rotation matrix and a first projection matrix; clustering elements in a rotation vector set obtained from the first projection matrix to generate a first normal vector sequence and a second normal vector sequence according to a first target classification; computing a second rotation matrix, using a second projection matrix as the target rotation matrix; obtaining a distance difference set, clustering to obtain a second target classification and using the element thereof and the corresponding second normal vector to obtain the target translation matrix. The present disclosure achieves a high-consistency and fast plane mapping in different coordinate systems.

### CROSS REFERENCE TO RELATED APPLICATIONS

This is a continuation application of International Application No. PCT/CN2019/081424 filed on 4 Apr. 2019.

### BACKGROUND OF THE INVENTION

### 1. Field of the Invention

The present disclosure relates to the technical field of image processing, and more particularly, to a plane-geometry consistency detection method, a computer device, and a storage medium.

### 2. Description of the Prior Art

Planes are the main feature used in artificial image scenes and have been widely used in many measuring and mapping methods. 3D mapping technology provides detailed and accurate information about the scene, and can be used for simultaneous localization and mapping (SLAM), augmented reality, video stabilization, 3D reconstruction and other fields because it can be applied to inexpensive sensors. It is becoming more popular and used by people day by day.

However, when considering its accuracy, speed, and robustness, the registration of the plane remains challenging. Many plane registration methods take a lot of time to retrieve the relative geometric constraints between frames by using various features, such as points, edges, planes, etc. Therefore, this kind of method needs to select the key frame structure to achieve a real-time performance.

In addition, some algorithms use projection-related methods, such as NDT (Normal Distribution Transform) or ICP (Itera. Closest Point), etc., which need good initial prediction and derive local optimal solutions.

Therefore, these methods are highly dependent on initialization to retrieve good geometric constraints.

### SUMMARY OF THE INVENTION

In view of the above-mentioned drawbacks of the prior art, the purpose of the present disclosure is to provide a plane-geometry consistency detecting method, a computer device, and a storage medium to solve the problems in the prior art.

In order to achieve the above-mentioned goal and other related goals, the present invention provides a plane-geometry consistency detection method, wherein each plane is uniquely represented in a coordinate system by a normal vector thereof and a distance between an origin of the coordinate system where the plane is located and the plane; the method is used to obtain a consistent conversion relationship from converting a first plane set composed of first planes in a first coordinate system to a second plane set composed of second planes in a second coordinate system, the conversion relationship is represented by a target rotation matrix and a target translation matrix; the method comprises: obtaining a first normal vector set and a first distance set respectively composed of first normal vectors and first distances used for representing the first planes, and a second normal vector set and a second distance set respectively composed of second normal vectors and second distances used for representing the second planes; obtaining the target rotation matrix, comprising: obtaining pairs of the first normal vectors in the first normal vector set and a pair of the second normal vectors of the second normal vector set whose angle matches an angle of the pair of the first normal vectors, computing a first rotation matrix converting each pair of the first normal vector set to a pair of the second normal vectors whose angle matches, and obtaining a first projection matrix of each first rotation matrix in a special orthogonal group SO(3) space; converting each obtained first projection matrix to a rotation vector by inverse transform of Rodriguez's rotation formula to obtain a rotation vector set; clustering each element in the rotation vector set to obtain a first target classification with most elements, respectively putting a pair of the first normal vectors and a pair of the second normal vectors as a computing basis of each element, which is the rotation vector, of the first target classification in a first normal vector sequence and a second normal vector sequence; and computing a second rotation matrix of converting the first normal vector sequence to the second normal vector sequence, and obtaining a second projection matrix of each second rotation matrix in the special orthogonal group SO(3) space as the target rotation matrix; obtaining the target translation matrix, comprising: subtracting each second distance in the second distance set from each first distance in the first distance set to obtain each distance difference and form a distance difference set; clustering each element in the distance difference set to obtain a second target classification with most elements; and combining second normal vectors that belong to a same plane with each second distances as a computing basis of each distance difference to obtain the target translation matrix according to the first distance and the second distance that are a computing basis of each element, which is the distance difference, in the second target classification.

In one embodiment, the first rotation matrix is obtained from a mapping relationship between a pair of first normal vectors together with another first normal vector perpendicular to them and a pair of second normal vectors, whose angle matches, together with another second normal vector perpendicular to them.

In one embodiment, the first normal vectors of each pair are not parallel; the first normal vector of each parallel first plane and the second normal vector of each parallel second plane are set to the same.

In one embodiment, an angle matching means that a difference between an angle between a pair of first normal vectors and an angle between a pair of second normal vectors is within a predetermined range.

In one embodiment, the clustering method comprises: inserting each element of the first target classification or the second target classification into a hash table, and establishing its corresponding index according to each element; or

In one embodiment, the index of each element is established according to contained data and a maximum reachable value thereof.

In one embodiment, the rotation matrix represents a vector extending along a direction of a rotation axis vector and having a length representing a rotation angle thereof; a method of establishing a first hash table for inserting the rotation vectors comprises: dividing a three-dimensional angle space into a plurality of cube-shaped cells of size ϵ³, ϵ∈(0,2π); and establishing a three-dimensional hash table of size N³ as the first hash table,

$$N = \frac{2 * π}{ϵ} ,$$

and computing the index

$${λ}_{r} = \frac{mod ( ( r + 2 π ) , 2 π )}{ϵ}$$

to insert the rotation vectors of the rotation vector set into the cells, wherein r is the rotation vector.

In one embodiment, a method of establishing a second hash table for inserting the distance differences comprises: dividing a three-dimensional space into a plurality of cube-shaped cells of size th_{d}³, th_{d}∈(0,maxD); establishing a three-dimensional hash table of size N³ as the second hash table,

$$N = \frac{max D}{{th}_{d}} ,$$

and computing the index

$${λ}_{d} = \frac{mod ( d + max D , max D )}{{th}_{d}}$$

to insert the distance differences of the distance difference set into the second hash table, wherein d is the distance difference, maxD is a maximum distance, and th_{d} is a cell size threshold.

In one embodiment, the first/second projection matrix is obtained by performing a singular value decomposition on the first/second rotation matrix to obtain two orthogonal matrixes.

In one embodiment, the method further comprises: computing a score of the obtained the plurality of target rotation matrixes, wherein the score relates to an amount of non-parallel plane groups for computing the target rotation matrixes and an amount of parallel planes constituting each plane group; wherein the target rotation matrix with a best score is the rotation matrix meeting the maximum geometric consistency of converting the first plane set to the second plane set.

In order to achieve the above-mentioned goal and other related goals, the present invention provides a computer device comprising: a processing unit and a storage unit; the storage unit for storing a computer program; and the processing unit for running the computer program to implement a plane-geometry consistency detection method; wherein each plane is uniquely represented in a coordinate system by a normal vector thereof and a distance between an origin of the coordinate system where the plane is located and the plane; the method is used to obtain a consistent conversion relationship from converting a first plane set composed of first planes in a first coordinate system to a second plane set composed of second planes in a second coordinate system, the conversion relationship is represented by a target rotation matrix and a target translation matrix; the plane-geometry consistency detection method comprising: obtaining a first normal vector set and a first distance set respectively composed of first normal vectors and first distances used for representing the first planes, and a second normal vector set and a second distance set respectively composed of second normal vectors and second distances used for representing the second planes; obtaining the target rotation matrix, comprising: obtaining pairs of the first normal vectors in the first normal vector set and a pair of the second normal vectors of the second normal vector set whose angle matches an angle of the pair of the first normal vectors, computing a first rotation matrix converting each pair of the first normal vector set to a pair of the second normal vectors whose angle matches, and obtaining a first projection matrix of each first rotation matrix in a special orthogonal group SO(3) space; converting each obtained first projection matrix to a rotation vector by inverse transform of Rodriguez's rotation formula to obtain a rotation vector set; clustering each element in the rotation vector set to obtain a first target classification with a most elements, respectively putting a pair of the first normal vectors and a pair of the second normal vectors as a computing basis of each element, which is the rotation vector, of the first target classification in a first normal vector sequence and a second normal vector sequence; and computing a second rotation matrix of converting the first normal vector sequence to the second normal vector sequence, and obtaining a second projection matrix of each second rotation matrix in the special orthogonal group SO(3) space as the target rotation matrix; obtaining the target translation matrix, comprising: subtracting each second distance in the second distance set from each first distance in the first distance set to obtain each distance difference and form a distance difference set; clustering each element in the distance difference set to obtain a second target classification with most elements; and combining second normal vectors that belong to a plane same with each second distances as a computing basis of each distance difference to obtain the target translation matrix according to the first distance and the second distance that are a computing basis of each element, which is the distance difference, in the second target classification.

In one embodiment, the first rotation matrix is obtained from a mapping relationship between a pair of first normal vectors together with another first normal vector perpendicular to them and a pair of second normal vectors, whose angle matches, together with another second normal vector perpendicular to them.

In one embodiment, the first normal vectors of each pair are not parallel; the first normal vector of each parallel first plane and the second normal vector of each parallel second plane are set to the same.

In one embodiment, an angle matching means that a difference between an angle between a pair of first normal vectors and an angle between a pair of second normal vectors is within a predetermined range.

In one embodiment, the clustering comprises: inserting each element of the first target classification or the second target classification into a hash table, and establishing its corresponding index according to each element.

In one embodiment, the index of each element is established according to contained data and a maximum reachable value thereof.

In one embodiment, the rotation matrix represents a vector extending along a direction of a rotation axis vector and having a length representing a rotation angle thereof; a method of establishing a first hash table for inserting the rotation vectors comprises: dividing a three-dimensional angle space into a plurality of cube-shaped cells of size ϵ³, ϵ∈(0,2π); and establishing a three-dimensional hash table of size N³ as the first hash table,

$$N = \frac{2 * π}{ϵ} ,$$

and computing the index

$${λ}_{r} = \frac{mod ( ( r + 2 π ) , 2 π )}{ϵ}$$

to insert the rotation vectors of the rotation vector set into the cells, wherein r is the rotation vector.

In one embodiment, a method of establishing a second hash table for inserting the distance differences comprises: dividing a three-dimensional space into a plurality of cube-shaped cells of size th_{d}³, th_{d}∈(0,maxD); establishing a three-dimensional hash table of size N³ as the second hash table,

$$N = \frac{max D}{{th}_{d}} ,$$

and computing the index

$${λ}_{d} = \frac{mod ( d + max D , max D )}{{th}_{d}}$$

to insert the distance differences of the distance difference set into the second hash table, wherein d is the distance difference, maxD is a maximum distance, and th_{d} is a cell size threshold.

In one embodiment, the first/second projection matrix is obtained by performing a singular value decomposition on the first/second rotation matrix to obtain two orthogonal matrixes.

In one embodiment, the method further comprises: computing a score of the obtained the plurality of target rotation matrixes, wherein the score relates to an amount of non-parallel plane groups for computing the target rotation matrixes and an amount of parallel planes constituting each plane group; wherein the target rotation matrix with a best score is the rotation matrix meeting the maximum geometric consistency of converting the first plane set to the second plane set.

In order to achieve the above-mentioned goal and other related goals, the present disclosure provides a computer-readable storage medium storing a computer program, performing the method when the computer program is ran by a processor.

As mentioned above, the plane-geometry consistency detection method, the computer device, and the storage medium of the present disclosure are achieved by obtaining a first normal vector set, a first distance set, a second normal vector set, and a second distance set; obtaining a target rotation matrix, comprising: obtaining pairs of the first normal vectors in the first normal vector set and a pair of the second normal vectors of the second normal vector set whose angle matches an angle of the pair of the first normal vectors, computing a first rotation matrix and a first projection matrix thereof; converting the obtained first projection matrix to a rotation vector to obtain a rotation vector set; clustering each element in the rotation vector set to obtain a first target classification with most elements to obtain a first normal vector sequence and a second normal vector sequence; computing a second rotation matrix of converting the first normal vector sequence to the second normal vector sequence, and using a second projection matrix thereof as the target rotation matrix; furthermore, obtaining a distance difference set from the first distance set and the second distance set, clustering to obtain a second target classification, and using the first distance and the second distance of the element thereof and the corresponding second normal vector to obtain the target translation matrix. The solution of the present disclosure achieves a high-consistency and fast plane mapping in different coordinate systems.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic flowchart of a plane-geometry consistency detection method according to an embodiment of the present disclosure.

FIG. 2 shows a schematic structure diagram of a computer device according to an embodiment of the present disclosure.

### DETAILED DESCRIPTION

The following specific embodiments illustrate the implementation of the present disclosure, and a person skilled in the art may readily understand other advantages and effects of the present disclosure from the content disclosed in the specification. The present disclosure may also be implemented or applied by other different specific implementations, and details in the specification may also be modified or changed based on different viewpoints and applications without departing from the spirit of the present disclosure. It should be noted that the embodiments of the present disclosure and the features of the embodiments may be combined with each other if there is no conflict.

Suppose that the first plane set in the first coordinate system F^{A} is expressed as {Pᵢ^{A}}, wherein the contained plane can be uniquely represented by a normal vector nᵢ^{A} thereof and a distance between an origin of the first coordinate system and the plane dᵢ^{A}, such that a point p^{A} located on Pᵢ^{A} satisfies:

nᵢ^{A}·p^{A}=dᵢ^{A}

and ∥nᵢ^{A}∥₂=1,dᵢ^{A}≥0(1).

The conversion relationship of rigid body motion between F^{A} and F^{B} satisfies f_{BA}=(R_{BA},T_{BA}), where R_{BA} is a rotation matrix converting F^{A} to F^{B}, T_{BA} is a translation matrix; correspondingly, the plane parameters of the physical plane observed in F_{A} and F_{B} satisfy:

nⱼ^{B}=R_{BA}·nᵢ^{A} (2)

(nⱼ^{B})^{T}·T_{BA}=dⱼ^{B}−dᵢ^{A} (3).

Wherein the derivation process of Eq. (3) is:

$$\begin{matrix}{( {n}_{j}^{B} )}^{T} \cdot {T}_{BA} = {( {n}_{j}^{B} )}^{T} \cdot ( {p}^{B} - {R}_{BA} \cdot {p}^{A} ) \\ = {( {n}_{j}^{B} )}^{T} \cdot {p}^{B} - {( {n}_{j}^{B} )}^{T} \cdot {R}_{BA} \cdot {p}^{A} \\ = {d}_{j}^{B} - {( {R}_{BA} \cdot {n}_{i}^{A} )}^{T} \cdot {R}_{BA} \cdot {p}^{A} \\ = {d}_{j}^{B} - {( {n}_{i}^{A} )}^{T} \cdot {R}_{BA}^{T} \cdot {R}_{BA} \cdot {p}^{A} \\ = {d}_{j}^{B} - {( {n}_{i}^{A} )}^{T} \cdot I \cdot {p}^{A} \\ = {d}_{j}^{B} - {( {n}_{i}^{A} )}^{T} \cdot {p}^{A} \\ = {d}_{j}^{B} - {d}_{i}^{A}\end{matrix}$$

Similarly, each plane Pⱼ^{B} in F^{B} can be uniquely represented by (nⱼ^{B}, dⱼ^{B}) satisfying the above equations.

Therefore, corresponding to the two plane sets {Pᵢ^{A}} and {Pⱼ^{B}}, the problem of establishing a maximum geometry consistency conversion relationship between them can be transformed into the following constraint optimization problem:

(R_{BA},T_{BA})=argmax( [symbol] _{R}_{_{BA}}_{,T}_{_{BA}}|) (4)

Then, find out the rigid body mapping relationship f_{BA} to maximize the cardinality of the sets [symbol] _{R}_{_{BA}}_{,T}_{_{BA}} defined below.

[symbol]

_{R}_{_{BA}}_{,T}_{_{BA}} [symbol] {(Pᵢ^{A},Pⱼ^{B})|f_{BA}(Pᵢ^{A})=Pⱼ^{B}} (5)

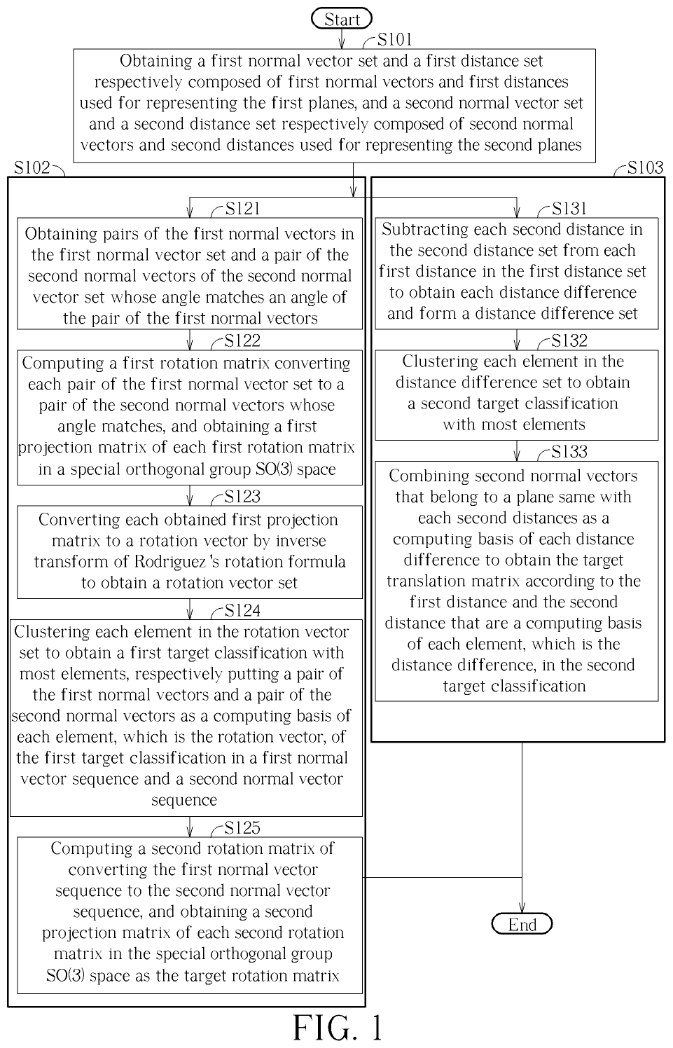

FIG. 1 shows a schematic flowchart of a plane-geometry consistency detection method according to an embodiment of the present disclosure. In fact, the method is used to obtain R_{BA},T_{BA} of the maximum consistency of the rigid body motion mapping between F^{A} and F^{B}.

The method comprises:

Step S101: obtaining a first normal vector set and a first distance set respectively composed of first normal vectors and first distances used for representing the first planes, and a second normal vector set and a second distance set respectively composed of second normal vectors and second distances used for representing the second planes.

Following the above, suppose that the first plane is expressed as Pᵢ^{A}, the corresponding first plane set is expressed as {Pᵢ^{A}}; the second plane is expressed as Pⱼ^{B}, the corresponding second plane set is expressed as {Pⱼ^{B}}; the first normal vector is expressed as nᵢ^{A}, and the second normal vector is expressed as nⱼ^{B}.

Step S102: obtaining the target rotation matrix R_{BA}.

In one embodiment, using the characteristics of rigid body motion, i.e. maintaining the norm and intersection of vectors, to compute the rotation matrix between plane sets in two coordinate systems is applied. In other words, by generating a rotation proposal from the angle between the planes, we can extract the maximum rotation consistency from it. In this regard, creating a rotation proposal first, ignoring the impossible rotation proposal and adopting a measurement mechanism based on voting (e.g. clustering) as described below to effectively measure the consistency.

Correspondingly, step S102 may specifically comprise:

Step S121: obtaining pairs of the first normal vectors in the first normal vector set and a pair of the second normal vectors of the second normal vector set whose angle matches an angle of the pair of the first normal vectors.

In one embodiment, assuming that the first plane set {Pᵢ^{A}} of size N_{A} is given, according to the angle between the pair of the first normal vectors, there are C_{N}_{_{A}}² angles θ_{i,j}.

Computed as:

$${θ}_{i , j} = arc cos ( \frac{{n}_{i} \cdot {n}_{j}}{‖ {n}_{i} ‖ \cdot ‖ {n}_{j} ‖} ) \qquad ( 6 )$$

Therefore, according to the computation of each angle to form a first angle group PG^{A} corresponding to the first plane set:

$$\begin{matrix}P {G}^{A} {=}^{Δ} \{ {θ}_{i , j} \vert {θ}_{i , j} = arc cos ( \frac{{n}_{i} \cdot {n}_{j}}{‖ {n}_{i} ‖ \cdot ‖ {n}_{j} ‖} ) \} and & ( 7 ) \\ \{ {n}_{i} ∈ {P}_{i}^{A} , {n}_{j} ∈ {P}_{j}^{A} \} . & ( 8 )\end{matrix}$$

From Eq. (8), it can be seen that nᵢ and nⱼ are the normal vectors of different planes in F^{A}.

Similarly, assuming that θ_{p,q} is the angle between the second normal vector nₚ of a plane and the second normal vector n_{q} of the other plane of the second plane set {Pᵢ^{B}}, then we can get C_{N}_{_{B}}² angles θ_{p,q} based on {Pⱼ^{B}} to form a second angle group PG^{B}.

Step S122: computing a first rotation matrix converting each pair of the first normal vector set to a pair of the second normal vectors whose angle matches, and obtaining a first projection matrix of each first rotation matrix in a special orthogonal group SO(3) space.

Specifically, the angle matching relationship between the paired angle groups PG^{A} and PG^{B} in the two plane sets is used to find out the mapping relationship between the plane sets. That is, between the angle θ_{i,j} of PG^{A} and the angle θ_{p,q} of PG^{B}, the minimum solution using two sets of normal to generate rotation proposal is:

$$\begin{matrix}{n}_{k} = \frac{{n}_{i} \times {n}_{j}}{‖ {n}_{i} \times {n}_{j} ‖} & ( 9 ) \\ {n}_{r} = \frac{{n}_{p} \times {n}_{q}}{‖ {n}_{p} \times {n}_{q} ‖} & ( 10 ) \\ {R}_{B A}^{*} = [ {n}_{p} {n}_{q} {n}_{r} ] \cdot {[ {n}_{i} {n}_{j} {n}_{k} ]}^{- 1} & ( 11 ) \\ [ U S V ] = S V D ( {R}_{BA}^{*} ) & ( 12 ) \\ {R}_{BA} = [ U \cdot {V}^{′} ] & ( 13 )\end{matrix}$$

Wherein nₖ is a vector constructed according to nᵢ and n₁ and perpendicular to them, nᵣ is a vector constructed according to nₚ and n_{q} and perpendicular to them; the reason of the construction is that the rotation matrix is a 3×3 matrix, and each normal vector is a 3×1 vector, and after having nᵢ and nⱼ, nₚ and n_{q}, still need to obtain a position-related vector (which may be a normal vector) of each corresponding coordinate system to create a 3×3 matrix. The method of obtaining the vertical vector of each pair of normal vector in this embodiment belongs to a minimal algebraic solution of R_{BA} with a smaller amount of computation.

In addition, in this embodiment, because R_{BA} is an orthonormal matrix falling in a Lie group SO(3), but R*_{BA} may not fall in SO(3). Hence, this embodiment uses an SVD method to project R*_{BA} into SO(3) to obtain R_{BA}. Since U and V must be orthogonal matrixes after SVD decomposition, R_{BA} is also an orthogonal matrix.

The R_{BA} obtained here is just a preliminary result. The computation method thereof may optimize the computation amount and further optimize the consistency.

Specifically, let N=max{N^{A},N^{B}}. There are C_{N}_{_{A}}²C_{N}_{_{B}}²<<N⁴ possible solutions in total. Here, we propose an effective measurement mechanism. In the average case, the amount of rotation proposals is significantly reduced to N².

Due to the characteristics of rigid body motion, an angle between the two planes is maintained in F^{A} and F^{B}. Therefore, it is not necessary to traverse all the elements of the two angle groups. In addition, the parallel planes are ignored because they have similar normal vectors having no contribution to rotation proposal set. For example, the selected pair of first normal vectors is not parallel, and the corresponding pair of the second normal vectors, whose angle matches, will not be parallel; and multiple parallel first normal vectors or multiple parallel second normal vectors may be regarded as the same when participating in the computation of the rotation proposal.

Selectively, a threshold thθ>0 is introduced as an acceptable angle noise threshold to establish a criterion for the matching angle, such that, for θ_{i,j}∈PG^{A}, θ_{p,q} in PG^{B} whose angle values are in the range of (θ_{i,j}−thθ,θ_{i,j}+thθ) are regarded as θ_{i,j}. Therefore, by search algorithms, such as binary search, the search time for possible matches of θ_{i,j} will be reduced to O(log N²); furthermore, in the worst case whose corresponding time complexity is O(N⁴), for example, the most planes are perpendicular to each other, the total time complexity of finding out all pairs whose angle matches in PG^{A} and PG^{B} will be reduced to O(N² log N) in average.

Then, the matching set M is defined as the following equations (14)-(15):

[symbol]

{(ij,pq,R)|abs(θ_{p,q}−θ_{i,j})<th_{θ}} (14)

θ_{i,j}∈PG^{A},θ_{p,q}∈PG^{B} (15)

For further consistency optimization, see the following steps:

Step S123: converting each obtained first projection matrix to a rotation vector by inverse transform of Rodriguez's rotation formula to obtain a rotation vector set.

Step S124: clustering each element in the rotation vector set to obtain a first target classification with most elements, respectively putting a pair of the first normal vectors and a pair of the second normal vectors as a computing basis of each element, which is the rotation vector, of the first target classification in a first normal vector sequence and a second normal vector sequence.

Step S125: computing a second rotation matrix of converting the first normal vector sequence to the second normal vector sequence, and obtaining a second projection matrix of each second rotation matrix in the special orthogonal group SO(3) space as the target rotation matrix.

For example, in order to reduce the search space, according to the inverse transform of Rodriguez's rotation formula, R is transformed into a three-dimensional rotation vector with the rotation axis (vector) as the direction and the angle as the length to obtain a more compact representation of R by the axis and the angle.

The rotation matrix R in SO(3) should satisfy R^{T}R=RR^{T}=I (where I is an identity matrix) and det(R)=1, which is the characteristic of the orthogonal matrix, and the rotation matrix r can be computed as follows:

$$\begin{matrix}A = \frac{R - {R}^{T}}{2} , ρ = {[ {a}_{32} {a}_{13} {a}_{21} ]}^{T} & ( 16 ) \\ s = ‖ ρ ‖ , c = \frac{( {r}_{11} + {r}_{22} + {r}_{33} - 1 )}{2} & ( 17 )\end{matrix}$$

Wherein, as the vector representation of the rotation axis, A may be derived according to Rodriguez's formula, r₁₁+r₂₂+r₃₃ is the component on the diagonal of the rotation matrix; due to cos θ=(r₁₁+r₂₂+r₃₃−1)/2, C is cos θ; and the modulus of ρ is sin θ, so s=sin θ.

If s=0 and c=1, then r=0; if s=0 and c=−1, then let v be equal to a non-zero column of R+I.

Then, get

$$u = \frac{ν}{‖ ν ‖} , r = S ( u π ) \qquad ( 18 )$$

In this embodiment, the S function is also involved to flip the coordinate symbol of r to ensure the uniqueness;

$$S ( r ) = \{ \begin{matrix}- r , & \begin{matrix}if ‖ r ‖ = π and ( ( {r}_{1} = {r}_{2} = 0 and {r}_{3} < 0 ) or \\ ( {r}_{1} = 0 and {r}_{2} < 0 ) or ( {r}_{1} < 0 ) )\end{matrix} \\ r , & otherwise\end{matrix} \qquad ( 19 )$$

More generally, if s≠0, then get:

$$u = \frac{ρ}{s} , θ = arc tan ( s , c ) , and r = u θ \qquad ( 20 )$$

Therefore, transforming the matching set M to be related to r:

[symbol]

{(ij,pq,r)|abs(θ_{p,q}−θ_{i,j})<th_{θ}} (21)

which is the rotation vector set.

Now, we still need to find out the most consistent rotation matrix, and the principle of clustering can be used; accordingly, there are many effective methods to extract the maximum consistency, such as using a hash table or performing a binary search to cluster each rotation vector to extract a classification with most elements, which is a rotation vector, to reconstruct the target rotation matrix.

In one embodiment, a hash table may be used to solve this problem.

In order to perform a clustering analysis on the rotation vector, a three-dimensional angle space is divided into a plurality of cube-shaped cells of size ϵ³ to store rotation vector of M, where ϵ∈(0,2π). Therefore, a first hash table of size N³ is generated, where N is given by the amount of cells in each rotation axis.

Establish a three-dimensional hash table of size N³ as the first hash table, where:

$$N = \frac{2 * π}{ϵ} \qquad ( 22 )$$

and compute the index:

$${λ}_{r} = \frac{mod ( ( r + 2 π ) , 2 π )}{ϵ} \qquad ( 23 )$$

to insert each rotation vector of rotation vector set into each cell; where r is the rotation vector.

After the hash table is obtained, the cell Cr with largest amount of elements n_{c}, which is the first target classification, according to Eq. (2) to get the best rotation proposal between {Pᵢ^{A}} and {Pⱼ^{B}} as the target rotation matrix.

Specifically, according to Cr, V_{A} and V_{B} with size 3×n_{c} are obtained. Specifically, since each normal vector is a 3×1 vector, then V_{A} and V_{B} in Eq. (24) and (25) are both 3*n_{c} matrixes. Therefore, in Eq. (26), Eq. (27) and (28) whose principle is similar to Eq. (12) and (13) are used to obtain the target rotation matrix R_{BA}:

V_{A}=[n₁^{A}n₂^{A} . . . nₙ_{_{c}}^{A}] (24)

V_{B}=[n₁^{B}n₂^{B} . . . nₙ_{_{c}}^{B}] (25)

R_{BA}=(V_{B}*V_{A}^{T})*(V_{A}*V_{A}^{T})⁻¹ (26)

[USV]=SVD(R*_{BA}) (27)

R_{BA}=[U·V′] (28)

Step S103: obtaining the translation matrix T_{BA}.

Specifically, for each rigid object, in rigid body motion, the distance between any two points thereof will not change with time. By comparing two plane set's difference set {dᵢ^{A}} and {dⱼ^{B}}, we can observe that there is a certain difference in the distance that satisfies most plane relations. Therefore, obtaining the translation matrix T_{BA} between F^{A} and F^{B} in step S103 can be derived from the following process described in detail:

Step S131: subtracting each second distance in the second distance set from each first distance in the first distance set to obtain each distance difference and form a distance difference set.

Step S132: clustering each element in the distance difference set to obtain a second target classification with most elements.

Step S133: combining second normal vectors that belong to a same plane with each second distances as a computing basis of each distance difference to obtain the target translation matrix according to the first distance and the second distance that are a computing basis of each element, which is the distance difference, in the second target classification.

For example, the distance set is defined as [symbol] {d_{i,j}}; suppose that the first distance is expressed as dᵢ^{A}, the second distance is expressed as dⱼ^{B}, then the elements in [symbol] , which is the distance difference, is expressed as:

dᵢⱼ=dᵢ^{A}−dⱼ^{B} (29)

Similar to the above embodiment, each distance difference of the distance difference set may be inserted into a second hash table.

Specifically, inserting all the elements, which are distance differences, in [symbol] into the second hash table according to the computed index; the computation method of the index comprises:

$${λ}_{d} = \frac{mod ( d + max D , max D )}{{th}_{d}} \qquad ( 30 )$$

wherein, maxD and th_{d} respectively represent the defined maximum distance and the size threshold of the cell storing the element. Finally, selecting the cell C_{d} with most elements, which is the second target classification, to compute the translation matrix T_{BA}.

Furthermore, extracting at least 3 elements {d_{i1,j1}, d_{i2,j2}, . . . , d_{im,jm}} from C_{d}, and according to Eq. (3), obtaining:

$$[ \begin{matrix}{n}_{{j}_{1}}^{T} \\ {n}_{{j}_{2}}^{T} \\ ⋮ \\ {n}_{{j}_{m}}^{T}\end{matrix} ] {T}_{B A} = [ \begin{matrix}{d}_{{i}_{1} , {j}_{1}} \\ {d}_{{i}_{2} , {j}_{2}} \\ ⋮ \\ {d}_{{i}_{m} , {j}_{m}}\end{matrix} ] = [ \begin{matrix}{d}_{{j}_{1}}^{B} - {d}_{i 1}^{A} \\ {d}_{{j}_{2}}^{B} - {d}_{i 2}^{A} \\ ⋮ \\ {d}_{{j}_{m}}^{B} - {d}_{{i}_{m}}^{A}\end{matrix} ]$$

and transformed into:

$${T}_{BA} = {[ \begin{matrix}{n}_{{j}_{1}}^{T} \\ {n}_{{j}_{2}}^{T} \\ ⋮ \\ {n}_{{j}_{m}}^{T}\end{matrix} ]}^{- 1} [ \begin{matrix}{d}_{{j}_{1}}^{B} - {d}_{i 1}^{A} \\ {d}_{{j}_{1}}^{B} - {d}_{i 2}^{A} \\ ⋮ \\ {d}_{{j}_{m}}^{B} - {d}_{{i}_{m}}^{A}\end{matrix} ] \qquad ( 31 )$$

Since d_{im,jm} is detectable and known, and the second normal vector corresponding to the same plane as dⱼ_{ₘ}^{B} is also detectable, the transpose matrix nⱼ_{ₘ}^{T} thereof can be obtained, that is, to obtain T_{BA}.

Based on the above-mentioned second hash table with

$${( \frac{max D}{{th}_{d}} )}^{3}$$

cells and O(N²) translation proposal, the time complexity of obtaining process of the translation matrix is O(N²).

In addition, as described in the abovementioned embodiment, for planes that are parallel to each other, because their normal vectors are parallel, the planes that are parallel to each other (for example, each parallel first plane, each parallel second plane) are regarded as one plane group. Then, when computing the rotation proposal, each plane group is equivalent to only participating in the computation once, which can reduce the amount of the computation.

However, after the hash table clustering analysis, each target rotation matrix will be voted to compute a score, and the target rotation matrix with the highest score is selected as the rotation matrix with the best consistency; the score is defined as the amount of all planes used to compute the corresponding target rotation matrix, and all planes include all the first planes Pᵢ^{A} of the first plane set {Pᵢ^{A}} in F^{A} and all the second plane Pⱼ^{B} of the second plane set {Pⱼ^{B}} in F^{B}.

Since the parallel planes are ignored when computing the first rotation matrix, the ignored parallel planes should be added back when computing the score.

For example, suppose that the target rotation matrix Rᵢ is computed based on m plane groups that are not parallel to each other, wherein each plane group has rⱼ parallel planes, wherein each plane group may be composed of a group of parallel Pᵢ^{A} or a group of parallel Pⱼ^{B}; the score of Rᵢ relates to m and rⱼ.

In one embodiment, the score computation method of Rᵢ may be: Σⱼ₌₁^{m}rⱼ

Suppose:

$${\sum }_{j = 1}^{m} {r}_{j} \leq N \qquad ( 32 )$$

Since each plane group is composed of n planes, according to the content obtained by the translation matrix T_{BA}, O(n²) is required to find out the matching plane. Therefore, the total time to compute the score of the rotation matrix Rᵢ is:

Σⱼ₌₁^{m}rⱼ²≤(Σⱼ₌₁^{m}rⱼ)²≤N² (33)

Therefore, it takes time of O(k*N²) in total to compute all the scores of the best k rotations

Then, the rotation matrix with the best score represents the maximum geometry consistency.

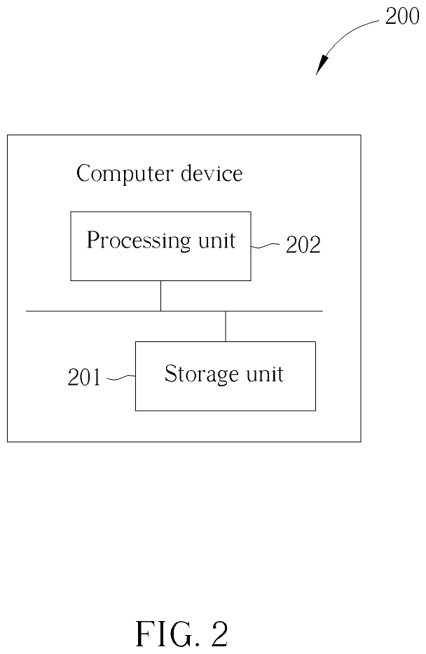

FIG. 2 shows a schematic structure diagram of a computer device according to an embodiment of the present disclosure.

The computer device 200 comprises: a storage unit 201 and a processing unit 202.

The storage unit is utilized for storing a computer program; and

The processing unit is utilized for running the computer program to implement, for example, the plane-geometry consistency detection method in the embodiment of FIG. 1, which specifically comprises:

obtaining a first normal vector set and a first distance set respectively composed of first normal vectors and first distances used for representing the first planes, and a second normal vector set and a second distance set respectively composed of second normal vectors and second distances used for representing the second planes; obtaining the target rotation matrix, comprising: obtaining pairs of the first normal vectors in the first normal vector set and a pair of the second normal vectors of the second normal vector set whose angle matches an angle of the pair of the first normal vectors, computing a first rotation matrix converting each pair of the first normal vector set to a pair of the second normal vectors whose angle matches, and obtaining a first projection matrix of each first rotation matrix in a special orthogonal group SO(3) space; converting each obtained first projection matrix to a rotation vector by inverse transform of Rodriguez's rotation formula to obtain a rotation vector set; clustering each element in the rotation vector set to obtain a first target classification with a most elements, respectively putting a pair of the first normal vectors and a pair of the second normal vectors as a computing basis of each element, which is the rotation vector, of the first target classification in a first normal vector sequence and a second normal vector sequence; and computing a second rotation matrix of converting the first normal vector sequence to the second normal vector sequence, and obtaining a second projection matrix of each second rotation matrix in the special orthogonal group SO(3) space as the target rotation matrix; obtaining the target translation matrix, comprising: subtracting each second distance in the second distance set from each first distance in the first distance set to obtain each distance difference and form a distance difference set; clustering each element in the distance difference set to obtain a second target classification with most elements; and combining second normal vectors that belong to a same plane with each second distances as a computing basis of each distance difference to obtain the target translation matrix according to the first distance and the second distance that are a computing basis of each element, which is the distance difference, in the second target classification.

In one embodiment, the first normal vectors of each pair are not parallel; the first normal vector of each parallel first plane and the second normal vector of each parallel second plane are set to the same.

In one embodiment, an angle matching means that a difference between an angle between a pair of first normal vectors and an angle between a pair of second normal vectors is within a predetermined range.

In one embodiment, the clustering comprises: inserting each element of the first target classification or the second target classification into a hash table, and establishing its corresponding index according to each element.

In one embodiment, the index of each element is established according to contained data and a maximum reachable value thereof.

In one embodiment, the rotation matrix represents a vector extending along a direction of a rotation axis vector and having a length representing a rotation angle thereof; a method of establishing a first hash table for inserting the rotation vectors comprises: dividing a three-dimensional angle space into a plurality of cube-shaped cells of size ϵ³, ϵ∈(0,2π); and establishing a three-dimensional hash table of size N³ as the first hash table,

$$N = \frac{2 * π}{ϵ} ,$$

and computing the index

$${λ}_{r} = \frac{mod ( ( r + 2 π ) , 2 π )}{ϵ}$$

to insert the rotation vectors of the rotation vector set into the cells, wherein r is the rotation vector.

In one embodiment, a method of establishing a second hash table for inserting the distance differences comprises: dividing a three-dimensional space into a plurality of cube-shaped cells of size th_{d}, th_{d}∈(0,maxD); establishing a three-dimensional hash table of size N³ as the second hash table,

$$N = \frac{max D}{{th}_{d}} ,$$

and computing the index

$${λ}_{d} = \frac{mod ( d + max D , max D )}{{th}_{d}}$$

to insert the distance differences of the distance difference set into the second hash table, wherein d is the distance difference, maxD is a maximum distance, and th_{d} is a cell size threshold.

In one embodiment, the first/second projection matrix is obtained by performing a singular value decomposition on the first/second rotation matrix to obtain two orthogonal matrixes. “/” means and/or, that is, the first projection matrix is obtained by performing a singular value decomposition on the first rotation matrix to obtain two orthogonal matrix and/or the second projection matrix is obtained by performing a singular value decomposition on the second rotation matrix.

In one embodiment, the method further comprises: computing a score of the obtained the plurality of target rotation matrixes, wherein the score relates to an amount of non-parallel plane groups for computing the target rotation matrixes and an amount of parallel planes constituting each plane group; wherein the target rotation matrix with a best score is the rotation matrix meeting the maximum geometric consistency of converting the first plane set to the second plane set.

In some embodiments, the storage unit 201 may comprise, but not limit to, a high-speed random access memory and a non-volatile memory. For example, one or more disk storage devices, flash memory devices, or other non-volatile solid-state storage devices.

The processing unit 202 may be a general-purpose processing unit comprising a central processing unit (CPU), a network processor (NP), etc.; it may also be a digital signal processor (DSP), an application specific integrated circuit (ASIC), a field programmable gate array (FPGA), or other programmable logic devices, discrete gate or transistor logic device, discrete hardware component.

In addition, various computer programs related to the above-mentioned method embodiment (such as the method embodiment in FIG. 1) may be loaded in a computer-readable storage medium, which may comprise, but not limit to, a floppy disk, an optical disk, a CD-ROM (compact disc read-only memory), a magneto-optical disc, a ROM (read-only memory), a RAM (random access memory), an EPROM (erasable programmable read-only memory), an EEPROM (electrically-erasable programmable read-only memory), a magnetic card or an optical card, a flash memory, or other types of mediums/machine-readable mediums suitable for storing machine executable instructions. The computer-readable storage medium may be a product that has not been connected to a computer device, or a component that has been connected to a computer device for use.

For specific implementation, the computer program is a routine, a program, an object, a component, a data structure, etc., that performs a specific task or implements a specific abstract data type.

In conclusion, the plane-geometry consistency detection method, the computer device, and the storage medium of the present disclosure is achieved by obtaining a first normal vector set, a first distance set, a second normal vector set, and a second distance set; obtaining a target rotation matrix, comprising: obtaining pairs of the first normal vectors in the first normal vector set and a pair of the second normal vectors of the second normal vector set whose angle matches an angle of the pair of the first normal vectors, computing a first rotation matrix and a first projection matrix thereof; converting the obtained first projection matrix to a rotation vector to obtain a rotation vector set; clustering each element in the rotation vector set to obtain a first target classification with most elements to obtain a first normal vector sequence and a second normal vector sequence; computing a second rotation matrix of converting the first normal vector sequence to the second normal vector sequence, and using a second projection matrix thereof as the target rotation matrix; furthermore, obtaining a distance difference set from the first distance set and the second distance set, clustering to obtain a second target classification, and using the first distance and the second distance of the element thereof and the corresponding second normal vector to obtain the target translation matrix. The solution of the present disclosure achieves a high-consistency and fast real-time plane mapping in different coordinate systems.

The above-mentioned embodiments only exemplarily illustrate the principles and effects of the present application, and are not used to limit the present disclosure. People skilled in this technology may readily modify or change the above-mentioned embodiments without departing from the spirit and the range of the present disclosure. Therefore, all equivalent modifications or changes made by people skilled in the art without departing from the spirit and the technical ideas disclosed in the present disclosure should be covered by the claims of the present disclosure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A plane-geometry consistency detection method, characterized in that each plane is uniquely represented in a coordinate system by a normal vector thereof and a distance between an origin of the coordinate system where the plane is located and the plane; the method is used to obtain a consistent conversion relationship from converting a first plane set composed of first planes in a first coordinate system to a second plane set composed of second planes in a second coordinate system, the conversion relationship is represented by a target rotation matrix and a target translation matrix; the method comprising:
obtaining a first normal vector set and a first distance set respectively composed of first normal vectors and first distances used for representing the first planes, and a second normal vector set and a second distance set respectively composed of second normal vectors and second distances used for representing the second planes;
obtaining the target rotation matrix, comprising:
obtaining pairs of the first normal vectors in the first normal vector set and a pair of the second normal vectors of the second normal vector set whose angle matches an angle of the pair of the first normal vectors, computing a first rotation matrix converting each pair of the first normal vector set to a pair of the second normal vectors whose angle matches, and obtaining a first projection matrix of each first rotation matrix in a special orthogonal group SO(3) space;
converting each obtained first projection matrix to a rotation vector by inverse transform of Rodriguez's rotation formula to obtain a rotation vector set;
clustering each element in the rotation vector set to obtain a first target classification with most elements, respectively putting a pair of the first normal vectors and a pair of the second normal vectors as a computing basis of each element, which is the rotation vector, of the first target classification in a first normal vector sequence and a second normal vector sequence; and
computing a second rotation matrix of converting the first normal vector sequence to the second normal vector sequence, and obtaining a second projection matrix of each second rotation matrix in the special orthogonal group SO(3) space as the target rotation matrix;
obtaining the target translation matrix, comprising:
subtracting each second distance in the second distance set from each first distance in the first distance set to obtain each distance difference and form a distance difference set;
clustering each element in the distance difference set to obtain a second target classification with most elements; and
combining second normal vectors that belong to a same plane with each second distances as a computing basis of each distance difference to obtain the target translation matrix according to the first distance and the second distance that are a computing basis of each element, which is the distance difference, in the second target classification.

2. The method of claim 1, characterized in that the first rotation matrix is obtained from a mapping relationship between a pair of first normal vectors together with another first normal vector perpendicular to them and a pair of second normal vectors, whose angle matches, together with another second normal vector perpendicular to them.

3. The method of claim 1, characterized in that the first normal vectors of each pair are not parallel; the first normal vector of each parallel first plane and the second normal vector of each parallel second plane are set to the same.

4. The method of claim 1, characterized in that an angle matching means that a difference between an angle between a pair of first normal vectors and an angle between a pair of second normal vectors is within a predetermined range.

5. The method of claim 1, characterized in that the clustering method comprises: inserting each element of the first target classification or the second target classification into a hash table, and establishing its corresponding index according to each element.

6. The method of claim 5, characterized in that the index of each element is established according to contained data and a maximum reachable value thereof.

7. The method of claim 6, characterized in that the rotation matrix represents a vector extending along a direction of a rotation axis vector and having a length representing a rotation angle thereof; a method of establishing a first hash table for inserting the rotation vectors comprises:
dividing a three-dimensional angle space into a plurality of cube-shaped cells of size ϵ³, ϵ∈(0,2π); and
establishing a three-dimensional hash table of size N³ as the first hash table,
$$N = \frac{2 * π}{ϵ} ,$$
and computing the index
$${λ}_{r} = \frac{mod ( ( r + 2 π ) , 2 π )}{ϵ}$$
to insert the rotation vectors of the rotation vector set into the cells, wherein r is the rotation vector.

8. The method of claim 6, characterized in that a method of establishing a second hash table for inserting the distance differences comprises:
dividing a three-dimensional space into a plurality of cube-shaped cells of size th_{d}, th_{d}∈(0,maxD);
establishing a three-dimensional hash table of size N³ as the second hash table,
$$N = \frac{max D}{{th}_{d}} ,$$
and computing the index
$${λ}_{d} = \frac{mod ( d + max D , max D )}{{th}_{d}}$$
to insert the distance differences of the distance difference set into the second hash table, wherein d is the distance difference, maxD is a maximum distance, and th_{d} is a cell size threshold.

9. The method of claim 1, characterized in that the first/second projection matrix is obtained by performing a singular value decomposition on the first/second rotation matrix to obtain two orthogonal matrixes.

10. The method of claim 3, characterized in that the method further comprises:
computing a score of the obtained the plurality of target rotation matrixes, wherein the score relates to an amount of non-parallel plane groups for computing the target rotation matrixes and an amount of parallel planes constituting each plane group;
wherein the target rotation matrix with a best score is the rotation matrix meeting the maximum geometric consistency of converting the first plane set to the second plane set.

11. A computer device, characterized in that the device comprises:
a processing unit and a storage unit;
the storage unit for storing a computer program; and
the processing unit for running the computer program to implement a plane-geometry consistency detection method; wherein each plane is uniquely represented in a coordinate system by a normal vector thereof and a distance between an origin of the coordinate system where the plane is located and the plane; the method is used to obtain a consistent conversion relationship from converting a first plane set composed of first planes in a first coordinate system to a second plane set composed of second planes in a second coordinate system, the conversion relationship is represented by a target rotation matrix and a target translation matrix;
the plane-geometry consistency detection method comprising:
obtaining a first normal vector set and a first distance set respectively composed of first normal vectors and first distances used for representing the first planes, and a second normal vector set and a second distance set respectively composed of second normal vectors and second distances used for representing the second planes;
obtaining the target rotation matrix, comprising:
obtaining pairs of the first normal vectors in the first normal vector set and a pair of the second normal vectors of the second normal vector set whose angle matches an angle of the pair of the first normal vectors, computing a first rotation matrix converting each pair of the first normal vector set to a pair of the second normal vectors whose angle matches, and obtaining a first projection matrix of each first rotation matrix in a special orthogonal group SO(3) space;
converting each obtained first projection matrix to a rotation vector by inverse transform of Rodriguez's rotation formula to obtain a rotation vector set;
clustering each element in the rotation vector set to obtain a first target classification with a most elements, respectively putting a pair of the first normal vectors and a pair of the second normal vectors as a computing basis of each element, which is the rotation vector, of the first target classification in a first normal vector sequence and a second normal vector sequence; and
computing a second rotation matrix of converting the first normal vector sequence to the second normal vector sequence, and obtaining a second projection matrix of each second rotation matrix in the special orthogonal group SO(3) space as the target rotation matrix;
obtaining the target translation matrix, comprising:
subtracting each second distance in the second distance set from each first distance in the first distance set to obtain each distance difference and forma distance difference set;
clustering each element in the distance difference set to obtain a second target classification with most elements; and
combining second normal vectors that belong to a same plane with each second distances as a computing basis of each distance difference to obtain the target translation matrix according to the first distance and the second distance that are a computing basis of each element, which is the distance difference, in the second target classification.

12. The computer device of claim 11, characterized in that the first rotation matrix is obtained from a mapping relationship between a pair of first normal vectors together with another first normal vector perpendicular to them and a pair of second normal vectors, whose angle matches, together with another second normal vector perpendicular to them.

13. The computer device of claim 11, characterized in that the first normal vectors of each pair are not parallel; the first normal vector of each parallel first plane and the second normal vector of each parallel second plane are set to the same.

14. The computer device of claim 11, characterized in that an angle matching means that a difference between an angle between a pair of first normal vectors and an angle between a pair of second normal vectors is within a predetermined range.

15. The computer device of claim 11, characterized in that the clustering comprises: inserting each element of the first target classification or the second target classification into a hash table, and establishing its corresponding index according to each element.

16. The computer device of claim 15, characterized in that the index of each element is established according to contained data and a maximum reachable value thereof.

17. The computer device of claim 16, characterized in that the rotation matrix represents a vector extending along a direction of a rotation axis vector and having a length representing a rotation angle thereof; a method of establishing a first hash table for inserting the rotation vectors comprises:
dividing a three-dimensional angle space into a plurality of cube-shaped cells of size ϵ³, ϵ∈(0,2π); and
establishing a three-dimensional hash table of size N³ as the first hash table,
$$N = \frac{2 * π}{ϵ} ,$$
and computing the index
$${λ}_{r} = \frac{mod ( ( r + 2 π ) , 2 π )}{ϵ}$$
to insert the rotation vectors of the rotation vector set into the cells, wherein r is the rotation vector.

18. The computer device of claim 16, characterized in that a method of establishing a second hash table for inserting the distance differences comprises:
dividing a three-dimensional space into a plurality of cube-shaped cells of size th_{d}, th_{d}∈(0,maxD);
establishing a three-dimensional hash table of size N³ as the second hash table,
$$N = \frac{max D}{{th}_{d}} ,$$
and computing the index
$${λ}_{d} = \frac{mod ( d + max D , max D )}{{th}_{d}}$$
to insert the distance differences of the distance difference set into the second hash table, wherein d is the distance difference, maxD is a maximum distance, and th_{d} is a cell size threshold.

19. The computer device of claim 11, characterized in that the first/second projection matrix is obtained by performing a singular value decomposition on the first/second rotation matrix to obtain two orthogonal matrixes.

20. The computer device of claim 13, characterized in that the method further comprises:
computing a score of the obtained the plurality of target rotation matrixes, wherein the score relates to an amount of non-parallel plane groups for computing the target rotation matrixes and an amount of parallel planes constituting each plane group;
wherein the target rotation matrix with a best score is the rotation matrix meeting the maximum geometric consistency of converting the first plane set to the second plane set.

21. A computer-readable storage medium, characterized in that the computer-readable storage medium stores a computer program, performing a method of claim 1 when the computer program is ran by a processor.
